(19) United States
(12) Patent Application Publication
(10) Pub. No.: US 2021/0406402 A1
(43) Pub. Date: Dec. 30, 2021

(54) PERSONAL DATA PLATFORM

(71) Applicant: EMC IP Holding Company LLC, Hopkinton, MA (US)

(72) Inventors: Amy N. Seibel, Cambridge, MA (US); Thinh Lam Truong Nguyen, Medford, MA (US); Akshaya Khare, Cambridge, MA (US); Victor Fong, Medford, MA (US); Kenneth Durazzo, San Jose, CA (US)

(21) Appl. No.: 16/917,268

(22) Filed: Jun. 30, 2020

(51) Int. Cl. G06F 21/62; G06F 21/60; G06Q 30/02

(52) U.S. Cl. CPC G06F 21/6263; G06K 19/06037; G06Q 30/0201; G06F 21/604

(57) ABSTRACT

A personal data platform is disclosed that provides users with control over their personal data. The data is stored on private infrastructure. Data is ingested from data sources and stored at the data platform. The data platform provides compute services that allow services to execute against the data to generate inferences without transmitting the data to a service provider. A user is also able to authorize access to data at multiple levels with service providers and others.

### FIELD OF THE INVENTION

Embodiments of the present invention generally relate to data platforms. More particularly, at least some embodiments of the invention relate to systems, hardware, software, computer-readable media, and methods for data platforms configured to give users control over their personal data.

### BACKGROUND

The number and types of devices that connect to the Internet is growing at a rapid rate. This growth is accompanied by an ever-increasing amount of data. Much of the data is personal or individual data that is regularly generated as users access services and retailers online. In addition to the data generated by activities such as browsing and social media, smart devices such as health monitors and security systems and online activities such as social media and online retail also generate personal data almost every day.

The data generated is often owned by a corresponding entity. Online retailers, for example, own the purchase histories of their customers and often store other personal information. The makers of smart devices or services that use smart devices often provide an interface that allows the data generated by those devices to be collected and analyzed. In order to use online services, in fact, individuals often relinquish control of their personal data.

Consequently, users are often unable to ensure or control their personal data and users cannot always control who their data is shared with. Further, the inability to control their own data prevents users from ensuring their privacy, hinders their ability to share data with trusted recipients, and impedes users from monetizing their data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example of relationships between users, service providers, and personal data;

FIG. 2 illustrates an example of a data platform that allows users to control their own personal data;

FIG. 3 illustrates an example of a method for aggregating personal data from data sources including service providers;

FIG. 4 illustrates an example of a user interface associated with a personal data platform;

FIG. 5 illustrates and example of localized compute in a personal data platform;

FIG. 6 illustrates and example of systems and methods for controlling access to personal data and to granting leveled access to service providers; and

FIG. 7 illustrates an example of authorizing access to personal data including in face-to-face situations.

### DETAILED DESCRIPTION OF SOME EXAMPLE EMBODIMENTS

Embodiments of the present invention generally relate to data platforms and to controlling access to personal data. More particularly, at least some embodiments of the invention relate to systems, hardware, software, computer-readable media, for data platform operations including aggregation operations, storing operations, sharing operations, access control operations, control operations and the like or combination thereof.

In general, example embodiments of the invention relate to a personal data platform that allows users to control and ensure their privacy, share their personal data with trusted recipients, monetize their data, and receive services from new vendors. The personal data platform can extend to data generated by smart devices, online activities and services, or the like.

The personal data platform is configured to provide users with control over their personal data. The data may be stored on privately owned infrastructure (e.g., the user's infrastructure) or in a remote location such as the cloud. In one example, personal data stored in the cloud (and in the local infrastructure) may be in an encrypted form such that the cloud provider does not have access to the user's data. In addition, the personal data platform provides compute capabilities that allows individuals to consume software services without sharing data with a service provider. In addition, the personal data platform provides multi-level sharing, which allows individuals to control what data is shared and to control how much data is shared with others.

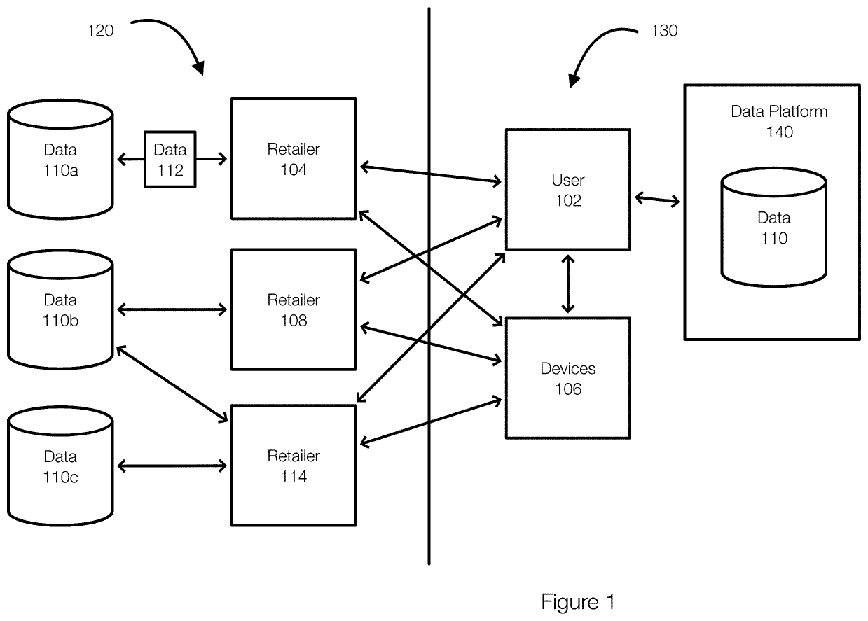

FIG. 1 illustrates examples of relationships that exist amongst data, users, service providers, and other entities. Generally, FIG. 1 illustrates relationships between service providers 120 (represented by retailers 104 and 108 and consumer 110) and users 130 (represented by user 102). The service providers come in different varieties and are often associated with different types of data. A service provider such an online clothing retailer, for example, may collect and store data that is distinct from an online medical provider or from a retailer that is associated with user devices.

FIG. 1 illustrates data 110a, 110b, and 110c. The data of the user collectively is represented as data 110 stored in the data platform 140. In FIG. 1, each service provider 120 may store their own data. The retailer 104 may store the data 110a, the retailer 108 may store the data 110b, and the consumer 110 may store the data 110c. The data 110a, 110b, and 110c is generally representative of data collected and/or owned by the service providers 120. However, each service provider typically stores their own data as illustrated in FIG. 1.

Embodiments of the invention give users control over their data such that the data 110a, 110b, and 110c may begin to decrease in amount, relevance, and/or timeliness (the data may be outdated). The most current and relevant data is stored in the data 110. At the same time, some interactions between the user 102 and the service providers 120 may result in a service provider having access to and storing personal data. For example, a user may provide a medical provider with specific data such as blood pressure readings, current prescriptions, or the like.

In FIG. 1, the user 102 is associated with the data 110a and often engages in interactions with the service providers 120 that generate new data. As a result, the data 110a continually grows or is continually updated. For example, the user 102 may purchase products from an online retailer 104. This interaction between the user 102 and the retailer 104 may result in data 112 associated with the transaction. The data 112 may be added to the data 110a that the retailer 104 already has. The data 110a may include information about the product purchased and may include information about how the user 102 arrived at the online retailer 104 and the like. The data 110a may contain data about previous purchases, previous products that were placed in a cart but not purchased, and the like. Because the retailer 104 is presumed to own the data 110a, the control of the user of the data 110a is limited.

The user 102 may also be associated with devices 106. These devices 106 may include, by way of example only, a health monitoring device, a security camera, smart devices, IoT (Internet of Things) devices, or the like. These devices 106, in addition to being associated with the user 102, may be associated with a retailer 108 or other service provider. In one example, the retailer 108 may collect data generated by the devices 108. The data generated by the devices 106 and collected by the retailer 108 is also included in or represented by the data 110. For example, data generated by a smartwatch or an app running on a smartwatch may be collected by the maker of the smartwatch, the maker of the app, or both. Further, this data may be made available to other apps or service providers. Each of the service providers 120 may be associated with different devices 106.

FIG. 1 further illustrates a retailer 114, which is another example of a service provider that may use or access the data 110b and/or store their own data 110c. In this sense, the retailer 114 is also a consumer of data stored by other service providers. For example, a doctor may desire to review health data generated by a wearable medical device. A home security service may review data generated by a security camera or system.

By way of example and not limitation, FIG. 1 illustrates many relationships between users, service providers, devices, and data. There may be other entities that have interest in the data 110a, 110b, and 110c. The service providers 120 or more specifically the retailers 104, 108 and 114 in this example control, respectively, the user data 110a, 110b, and 110c.

Embodiments of the invention allow the user to aggregate the data stored by the service providers and place the data 110 under the user's control. Once aggregated, the personal data platform 140 enables the user 102, for example, to control the data 110 and control access to the data 110.

As previously stated, the data 110 is similar to the data 110a, 110b, and 110c. Even if the data 110a, 110b, and 110c exists when embodiments of the invention are implemented by the user, the data 110a 110b, and 110c may become more limited in scope over time at least because the user 102 is enabled to take control of the data 110 that has been aggregated or accumulated by the user and stored in the data platform 140.

As previously stated, data is conventionally owned and stored by each of the service providers 120 based on their use case. A bank may store financial data, a credit card company may store purchase and payment history. A health device company may store health information such as daily steps, heartbeats, or the like. As illustrated in FIG. 1, because the data 110a, 110b, and 110c is stored by the service providers 120, the privacy of the user 102 may be compromised at least because administrators or other persons associated with these service providers 120 may have access to personal data. The user 102 may also be subject to security breaches and the user's data may be shared with other institutions (including other governments) without their consent.

These concerns are not alleviated when the data 110a, 110b, and 110c is stored in the cloud. Administrators of the cloud service provider, in addition to persons at the retailers, may have access to the data 110a, 110b, and 110c and the user still does not have control of the data or of their privacy.

When the user consumes services from a service provider, the service provider may need some personal data. A health inference service provider may need health telemetry data. Once the data is shared with the service provider, the user loses control of that shared data. Further, many service providers may use cloud compute services to process personal data. This type of model may introduce privacy and/or control problems. The personal data, when in memory, may be accessible to the cloud service provider.

This concern is alleviated by embodiments of the invention, which allows compute to occur at the data platform 140. This may allow inferences to be generated from the user's data without providing the actual data to the service provider.

Embodiments of the invention thus relate to a data platform that allows a user to control their data, control access to their data, and the like. Embodiments of the invention further relate to copying data from the storage of service providers to the storage of the user. Embodiments of the invention can run on privately-owned infrastructure and/or the cloud. When using cloud infrastructure, the user may not need to setup or maintain their own infrastructure. Alternatively, embodiments of the invention may be embodied as a turn-key appliance. The data may be encrypted in any of these embodiments to further strengthen privacy.

The data platform may reduce security risks and improve privacy. In addition, the data platform provides different mechanisms to consume services provided by service providers and provide security for individuals. In addition, embodiments of the invention can execute in a single tenant model or a multi-tenant model.

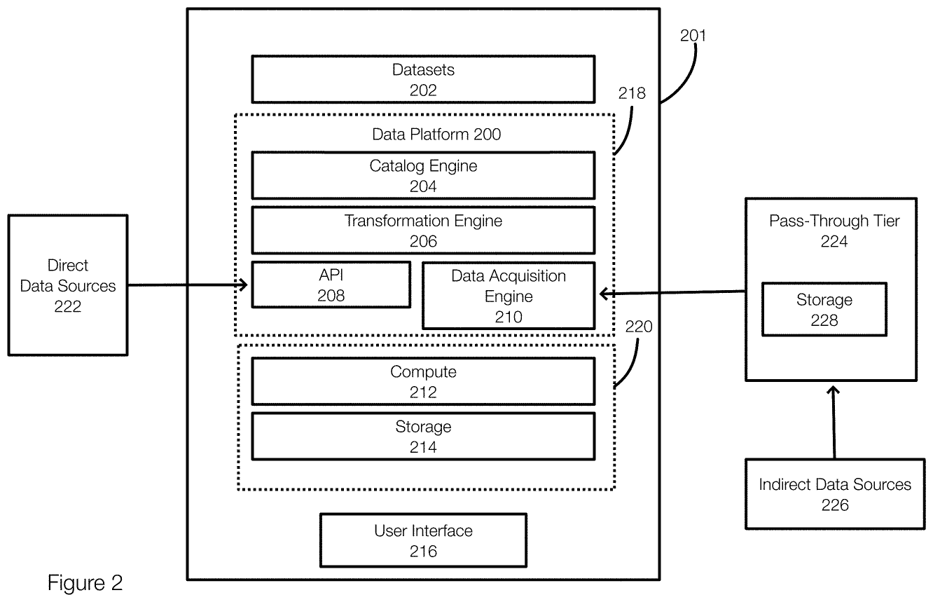

FIG. 2 illustrates an example of a data platform that may be implemented in private infrastructure and/or in an infrastructure such as the cloud (e.g., a datacenter). The data platform 200 is typically configured to acquire data from data sources such as direct data sources 222 and indirect data sources 226. Service providers (e.g., the service providers 120 illustrated in FIG. 1) are examples of data sources from which personal data is retrieved and ingested into the data platform 200.

Examples of the direct data sources 222 include, but are not limited to, smart home devices, home security systems, health monitors, baby monitors, and the like. The direct data sources 222 may be connected to the same local area network as the data platform 200. As a result, the direct data sources 222 can connect to and directly communicate with the data platform 200. In one example, the direct data sources 222 may communicate via an application programming interface (API) 208. The direct data sources 222 are thus configured to transmit data to the data platform 200 through the API 208.

As described in more detail below, the data received into the data platform 200, which may be running on infrastructure 201, may be transformed by a transformation engine 206 and catalogued by a catalog engine 204, which are both included in embodiments of the data platform 200. The transformed and/or cataloged data is stored as datasets 202, which may be encrypted.

Data sources such as the indirect data sources 226 may not be on the same network as the data platform 200. These indirect data sources 226, due to various restrictions such as firewalls, may need a pass-through tier 224. The pass-through tier 224 is used to receive and/or transmit data to the indirect data sources, which may also be service providers. In one example, the data platform 200 and the indirect data sources 226 may agree on end-to-end encryption such that the data cannot be read when stored, for example temporarily in the storage 228, of the pass-through tier 224.

Examples of indirect data sources 226 include service providers such as online retailers, banks, hospitals, or the like or combination thereof.

The indirect data sources 226 may be capable of sending data to the pass-through tier 224 on their own initiative or based on a request from a user. The request may be generated through a user interface 216. Data acquired from the indirect data sources 226 may be acquired or updated on request, at scheduled intervals, or the like. Further, the same security protocols applied to the local environment of the data platform 200 may also be applied to the pass-through tier 224.

For example, the indirect data sources 226 may write data to the storage 228 when requested, per a predetermined schedule, or in another fashion. The data platform 200 may include a data acquisition engine 210 that is configured to retrieve the data from the storage 228. In this manner, the data from the indirect data sources 226 is ingested into the data platform 200. In one example, the data acquisition engine 210 includes an API. The data acquisition engine 210 may initiate communication with the pass-through tier 224 and/or respond to a notification or request from the pass-through tier 224 or the data source that data is available for retrieval or transmission.

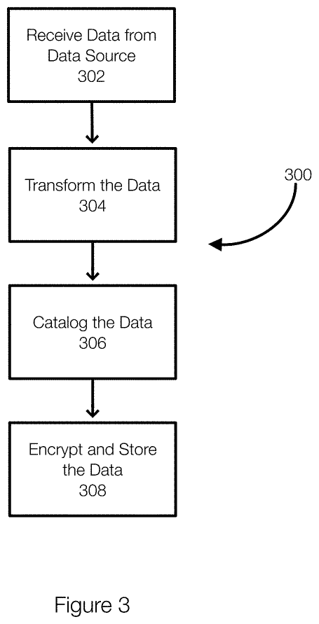

FIG. 3 illustrates an example of data aggregation when ingesting or aggregating data from data sources. While a user may interact with the data platform 200 via a user interface to manually aggregate data, the data aggregation from the various data sources may also be automated. For example, once a data source is identified and the communication method is established, the actual retrieval of the data may be automated.

In the method 300, the data is received 302 from a data source such as a direct data source or an indirect data source. Although embodiments of the invention allow for multiple data transmission mechanisms (e.g., UDP, TCP, HTTP, message bus, pub/sub, or the like), the data may be encrypted end-to-end during the transmission process.

After receiving the data, the data is transformed 304. The transformation may be dependent on a data-type of the received data. However, embodiments of the invention can handle any data type or can be configured to handle any data type. Further, the data may be decrypted prior to transformation. For example, pictures may all be transformed into a format such as JPEG or into a custom format. Text may be transformed into XML data or text data. Transforming 304 the data may also include compressing the data after conversion into a pre-determined format. While data received by the data platform may be structured or unstructured, the transformation process typically results in structured data.

After the data is transformed 304, the data is cataloged 306. Cataloging 306 the data may include generating additional metadata that describes the data or tagging the data. Data can be categorized and tagged. Information from a blood pressure cuff, for example, may be tagged or categorized as health data and may include additional tags that are more precise such as blood pressure measurement, systolic reading, diastolic reading, or the like. Different metadata designs can be used. For example, tree-based structures of categories and sub-categories may be used. Tag-based metadata may also be used. In addition, automations can be configured to auto-catalog incoming data from each of the data sources.

In one example, a plug-in based implementation is used for transforming 304 the data and for cataloging 306 the data. A plugin associated with a smart watch, for example, may be configured to transform and catalog data from the smart watch. In addition, machine learning algorithms may be provided such that the transforming and cataloging processes can be automated and improved. Existing transformations and cataloged data may be used as training data.

Next, the data is encrypted and stored 308 in the datasets of the data platform.

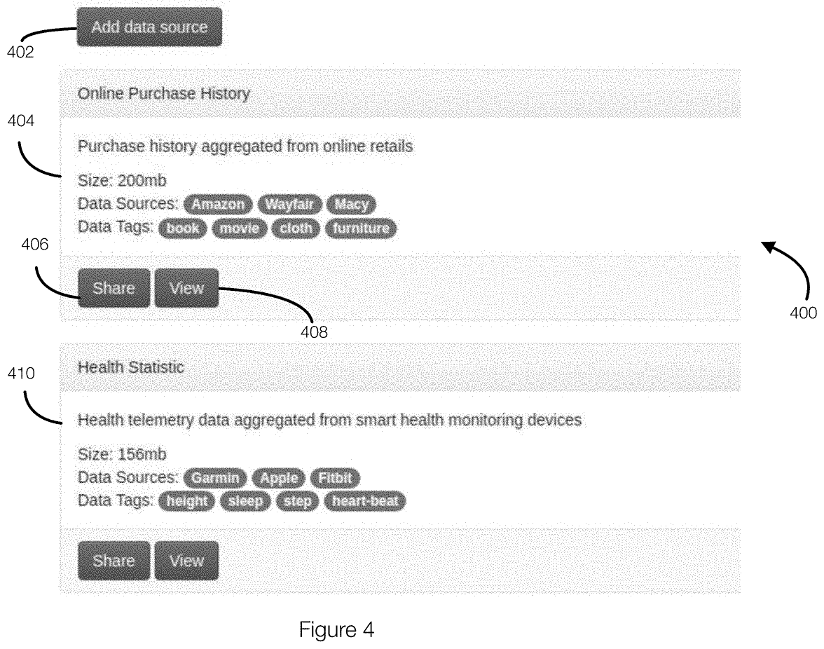

FIG. 4 illustrates an example of a user interface 400. Using the user interface 400, data can be aggregated, retrieved, or received from a data source, shared, and/or viewed. The user interface 400 is an example of allowing a user to control their data that has been stored in the data platform.

FIG. 4 includes a button 402 (or other user interface element) that starts a process of adding a data source to the data platform. When selected, the process of adding a data source may include providing a URL (Uniform Resource Locator) that can be accessed automatically or manually. For example, the data source may provide an API that can be accessed and through which data can be downloaded (directly or through the pass-through tier). For example, a user may input www.<retailer>.com\api>, which can be used to initiate the process of acquiring user data from the data source.

FIG. 4 also illustrates data (or links to data) that has been transformed and/or categorized. The online purchase history 404 is an example of data that is categorized as online purchase history data. The data sources for online purchase history data include Amazon, Wayfair, and Macys. The data has been cataloged, by way of example only, with tags such as book movie, cloth, and furniture. The add data source 402 may allow a data source to be added to this category. Similarly, health data has been categorized as health statistic data 410. The health statistic data 410 is retrieved from data sources that include Garmin, Apple, and Fitbit. The data has been cataloged using tags such as height, sleep, step, and heart-beat.

The share button 406 and the view button 408 allow the data to be shared and/or viewed. The view button 408 may allow the user to view the data that has been aggregated. This may allow the user to make corrections or other changes. The share button 406 may allow the user to share the data with another entity. The share button 406 may also allow a user to indicate or specify how data is to be shared with specific service providers. For example, the user may select to share raw data with a doctor, but only share doctor reports with an insurance company. Thus, access to the data and the manner in which the data is shared is controlled by the user.

Returning to FIG. 2, the data platform 200 may also be associated with and run on hardware 220. The hardware 220 includes compute 212 and storage 214. The hardware 220 allows the data platform 200 to perform localized compute using the datasets 202.

More specifically, many service providers may need personal data to provide a more personalized user experience. For example, a clothing retailer may use a previous purchase history to obtain information such as size, favorite or preferred style, preferred color, or the like. This may allow the clothing retailer to recommend products to the user.

Embodiments of the invention allow this type of analysis to be performed locally. More specifically, the user is not required to share any data with the service provider. This is achieved, in effect, by bringing compute to the data platform 200 rather than sending data to the service provider for compute purposes.

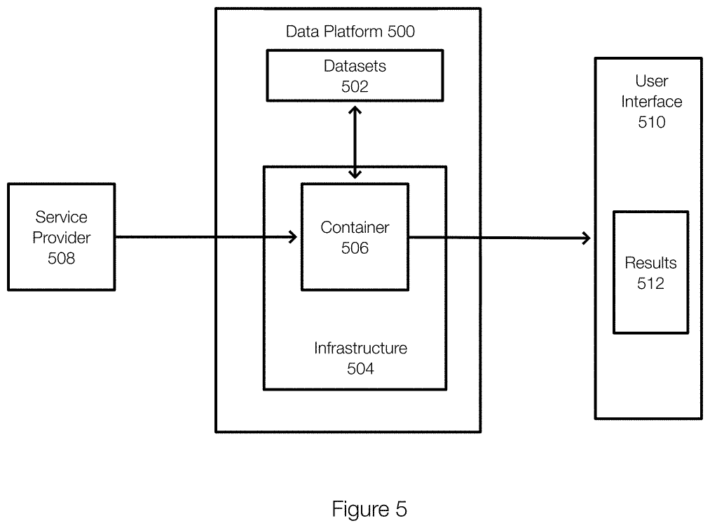

FIG. 5 illustrates an example of localized compute. FIG. 5 illustrates a data platform 500 that is associated with a user. The data platform 500 stores or has access to datasets 502, which stores personal data of the user that has, for example, been transformed and cataloged.

In this example, the service provider 508 may provide the data platform 500 with their services in a pre-defined format, such as container 506. The container 506 can be downloaded to the data platform 500 and installed or executed using the infrastructure 504. The container 506 can execute against the datasets 502 and present results 512 in a user interface 510 to the user. The user may allow the results to be shared with the service provider, for example through the pass-through tier or directly.

In one example, the infrastructure 504 or compute environment may be controlled. For example, the infrastructure 504 in which the container or other executable executes may not have an external network connection. This ensures that the container 506 cannot copy personal data out of the data platform 500. The service provider 508 may provide their own user interface to interact with the user. For example, a service provider can offer a notification system through the pass-through tier and/or mobile devices.

In other examples, a user interface may be provided to provide service for users using the data platform. The user interface could be hosted elsewhere, for example on a mobile or other consumer device. The service provider may also provide a user interface to run inside the data platform. As a result, embodiments of the invention provide flexibility and allow the user interface to be run in different locations and to accommodate different use cases.

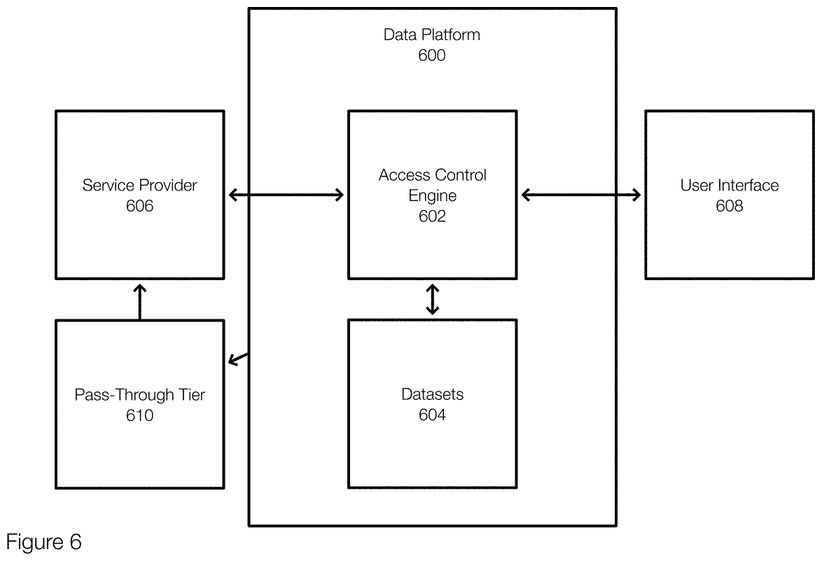

FIG. 6 illustrates an example of an access control engine configured to control a level of data access. The access control engine 602 may be accessed through a user interface. The access control engine 602 provides controls or allows the user to control how the various service providers access data. Through a user interface 608, a user can access the access control engine 602 of the data platform 600 to set controls or to set access levels on the datasets 604. Each service provider and each person the data is shared with may be controlled separately and independently of other service providers. Controls can be set based on service provider, data type, privacy levels, or the like or combination thereof. Other criteria for controlling access or for setting levels may include dates, details, size, or the like.

When the datasets or data of the user are accessed or shared, the access control engine 602 may control access by evaluating permissions or access permissions and allow access to the datasets 604 accordingly.

For example, data can be shared as raw data (the highest permission or access level) or at lower levels. For example, a patient may share raw lab results with a doctor office, but only share doctor reports with an insurance company. Although each service provider may gain access to and duplicate a part of the data, the user can set permissions and maintain full control of the personal data.

The ability to share data can also be achieved in different manners. Data transmission can be done directly from a pass-through tier to a server hosted by the service provider. In this example after evaluating permissions, the data platform 600 may send the relevant data to a pass-through tier 610. The service provider 606 may be notified that data is available and may retrieve the data from the pass-through tier 610. In this and other examples, the data is encrypted (usually with a provider-specific key) and the key to decrypt may be transmitted separately.

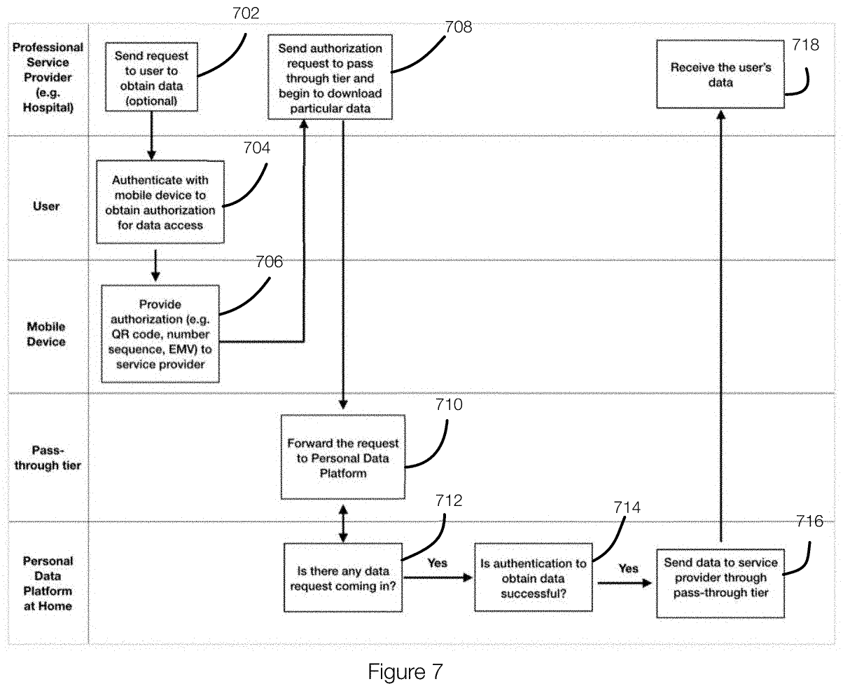

FIG. 7 illustrates another example of data transmission from a data platform to a service provider. FIG. 7 illustrates the various components and/or users and their relationships as the data is accessed and provided to a service provider. In this example, a request is sent 702 to obtain data. This may be performed using a device associated with a hospital or other service provider. The request can be sent via email, text, over Bluetooth, or the like. Next, the user may authenticate 704 with their mobile device to obtain authorization for accessing the data platform. The mobile device may provide authorization 706 (e.g., a QR code, number sequence, EMV) to the service provider (the hospital in this example). By presenting the authorization, access to the data platform may be granted. The authorization 706 may be associated with a specific service provider and may allow the data platform to enforce access levels.

Although FIG. 7 illustrates an example of a method that begins with a request from the service provider, the data owner could initiate the request as well. In addition, the order of elements set forth in FIG. 7 may be different. For example, the user may initiate a request and provide authorization to the service provider without receiving a request from the service provider. In addition, the path of the data retrieved from the personal data platform in response to the authorization may vary.

The service provider can then initiate the process to retrieve the data once the service provider has the authorization. The service provider may receive the authorization by reading the QR code, receiving the number via text or email, or the like.

The service provider sends 708 an authorization request, which includes the authorization, to a pass-through tier to begin to download specific data. The data platform may determine that a data request has been received 712 or is posted at the pass-through tier. Next, the authentication is verified 714. If the authentication is successful or verified, the requested data is retrieved from the data platform and the retrieved data, usually in an encrypted form, is sent 716 to the service provider through the pass-through tier. The service provider then receives 718 the user's data.

As previously stated, the path of the data retrieved from the data platform may vary. The data may pass through the mobile device (or other user device) as part of the pass-through tier. For example, a user may share data with a retail store in which the user is present. However, the data could also go directly from the pass-through tier to cloud services provided by the service providers.

This example demonstrates that devices such as a smart phone can be used as a transmission medium or used to facilitate the transfer of data through a peer-to-peer transfer mechanism in a face-to-face scenario (e.g., the user is at the hospital and wants to give the provider certain data). In this example, the user, who is entering a hospital, can provide permission to share health related data. In one example, the service provide may agree to allow data to be stored by the user rather than with the hospital. For example, data generated by medical devices used when a user is a patient in a hospital may be stored by the hospital or in the data platform of the user. The rules may be governed by applicable regulations.

In this example, the mobile device does not actually store the data, but acts as a transmission medium to link the user with the data source. Data will not be decrypted or viewed inside the mobile device. The data is only decrypted and viewed at the destination. The data path is thus from the data platform to the pass-through tier-to the mobile device, and to the service provider receiver (e.g., using Wi-Fi or Bluetooth).

Instead of storing personal data with a third party vendor or cloud infrastructure provider (although this is contemplated by embodiments of the invention), the personal data may be stored in privately-owned infrastructure (such as a desktop or home edge-station). This not only provides additional data control, but also increases the security measure by not utilizing third party infrastructure.

In addition, instead of transmitting data over to service providers (e.g. hospitals) and risking personal data being duplicated, this invention instead brings compute to the data by offering a standardized compute environment. In other words, the computation/inference service will be executed on private infrastructure instead of in the cloud or in the infrastructure of the service provider. Because the data is never transmitted outside of the data platform, and the compute is executed within the platform, security risk decreases.

Thus, instead of transmitting data to the service provider, embodiments of the invention bring the service to the data platform for execution. Because the user owns the infrastructure that executes the service, additional restrictions can be applied to the environment to further reduce security risk. For example, the execution environment might not have a network connection, so that the data would not be duplicated or sent back to the platform it originated on. More specifically, even if the execution environment prevents the user data from being transmitted out of the personal data platform, the execution environment may allow inferences generated by the service to be transmitted. Further, there is sufficient connectivity during execution of the service such that the service can use the data stored in the personal data platform to generate the inferences. More specifically, the inference could be computed on the personal data platform, in the on-premise environment. In this example, the inference model (e.g., a container or other executable) is transmitted to the personal data platform from the service provider. This allows the inference model to be executed using the user's infrastructure and gives the user more control over the user's data. In one example, only the inference is returned to the service provider. Generally, the user is able to control what type of data is transferred back to the service provider.

A pass-through tier addresses various firewall issues, so that other cloud services or mobile devices can access data from a personal data platform hosted in a private network.

The aggregation of personal data from multiple sources, on a user's personal infrastructure, is disclosed. When aggregating data, the data may be categorized, classified, and or tagged by content type (and other attributes). Classification and/or tagging could also be done automatically. Data could also be shared based on the classification, category, tag type, service provider, size, and other criteria.

The use of devices (e.g., mobile devices, IoT devices and other client devices) as a data transmission medium is disclosed. In this context, a data transmission medium refers to a data transfer hub that allows for the data source and recipient to be associated in real-time, and in the location that the user needs (e.g. to pass personal healthcare data from a patient to a doctor in real-time, during an appointment).

The ability of a user to control the sharing of their data at a granular level is disclosed, as is the user interface that will enable uses to do so on private infrastructure. This covers which types of data will be shared, who it will be shared with, and what portions of that data will be shared.

For example, a person generates a large amount of health data throughout her lifetime, such as doctor reports, lab results, health telemetry from smart devices, scan images, etc. These data can serve as input to continuously monitor the health of the patient, and to diagnose new problems when they appear.

Instead of trusting a third party vendor (such as a hospital, health monitor provider, etc.) to store this important data, individuals store this data on infrastructure of her own choosing.

As new telemetry and data (such as heartrate, body temperature, doctor reports, lab results, etc.) are generated, each device acts as a data source that feeds data into this personal data platform.

When the patient needs to get insurance quotes (for example, life insurance, health insurance, or driver insurance), each insurance company may provide inference services that can execute on this data platform to make inference based on these data. For example, an internet-connected car or connected vehicle could be uploading driving data that is captured and moved into the personal data platform. When the car owner needs to obtain/renew auto insurance, the insurance inference model could be executed on the data set (data collected from the connected vehicle). The inference may be used to provide an insurance quote based on the user's actual driving data. In addition, the user has control of whether to share this data or allow the data to be used for generating inferences. The user can opt into or out of inferencing and data sharing.

In another example, a traveler may need to be admitted into a hospital in a foreign country or in a location that may not have any data about the user. Embodiments of the invention allow this user to share data using the patient's mobile device (with user consent) and the data can be transferred to the hospital, so that the hospital can gain access to the patient's medical history. The patient could also share certain health information with a loved one or a caregiver. Thus, the personal data platform allows the user to share data from locations geographically distant from the user's infrastructure and using different networks to transfer the data.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data platform operations. Such operations may include, but are not limited to, data control operations, data access operations, data store operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements or local and private infrastructure. Any of these example storage environments, may be partly, or completely, virtualized.

Example public cloud storage environments in connection with which embodiments of the invention may be employed include, but are not limited to, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

Following are some further example embodiments of the invention. These are presented only by way of example and are not intended to limit the scope of the invention in any way.

Embodiment 1. A method comprising: receiving a request from a service provider to obtain personal data, providing the service provider with an authorization, sending the request and the authorization to a data platform of a user, authenticating the authorization, and sending the personal data to the service provider from the data platform.

Embodiment 2. The method of embodiment 1, further comprising receiving the request at a mobile device, wherein the mobile device is configured to provide the authorization.

Embodiment 3. The method of embodiment 1 and/or 2, wherein the authorization is one of a QR code, a number or alphanumerical sequence, or an EMB.

Embodiment 4. The method of embodiment 1, 2, and/or 3, further comprising sending the request and the authorization to a pass-through tier, wherein the data platform retrieves the request and the authorization from the pass-through tier.

Embodiment 5. The method of embodiment 1, 2, 3, and/or 4, further comprising accessing the data based on permissions associated with the service provider.

Embodiment 6. The method of embodiment 1, 2, 3, 4, and/or 5, further comprising sending the personal data through a mobile device to the service provider.

Embodiment 7. A non-transitory storage medium having stored therein instructions that are executable by one or more hardware processors to perform the method any one or of embodiments 1, 2, 3, 4, 5, and/or 6 or any combination of one or more of any elements of embodiments 1, 2, 3, 4, 5, and/or 6.

Embodiment 8. A method comprising aggregating data from multiple data sources into a data platform, wherein first data from first data sources is aggregated directly into the data platform through an API and second data is aggregated through a pass-through tier, transforming the first and the second data into structured data, cataloging the structured data such that the structured data is stored as datasets, and controlling access to the structured data and generating inferences for a service provider.

Embodiment 9. The method of embodiment 8, further comprising receiving a service from the service provider and running the service against the datasets to generate the inferences.

Embodiment 10. The method of embodiment 8 and/or 9, further comprising restricting the service from copying the structured data to the service provider.

Embodiment 11. The method of embodiment 8, 9, and/or 10, further comprising setting access levels for the service provider.

Embodiment 12. The method of embodiment 8, 9, 10, and/or 11, further comprising cataloging the structured data by content type.

Embodiment 13. The method as recited in any of embodiments 1-12 or portions thereof.

Embodiment 14. A non-transitory storage medium having stored therein instructions that are executable by one or more hardware processors to perform the operations of any one or more of embodiments or portions thereof of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

In one example, the physical computing device includes a memory which may include one, some, or all, of random access memory (RAM), non-volatile random access memory (NVRAM), read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a request from an entity to obtain personal data;
providing the entity with an authorization;
sending the request and the authorization to a data platform of a user;
authenticating the authorization; and
sending the personal data to the entity from the data platform.

2. The method of claim 1, further comprising receiving the request at a client device, wherein the client device is configured to provide the authorization.

3. The method of claim 2, wherein the authorization is one of a QR code, a number or alphanumerical sequence, or an EMB.

4. The method of claim 1, further comprising sending the request and the authorization to a pass-through tier, wherein the data platform retrieves the request and the authorization from the pass-through tier.

5. The method of claim 1, further comprising accessing the data based on permissions associated with the entity.

6. The method of claim 4, further comprising sending the personal data through a client device to the entity.

7. The method of claim 1, wherein the entity is at least one of a service provider, a different end user, a retailer, or a consumer.

8. The method of claim 2, wherein the client device is at least one of a mobile device, an IoT device and wherein the authorization is configured in advance or performed on a case-by-case basis.

9. A non-transitory storage medium having stored therein instructions that are executable by one or more hardware processors to perform operations comprising:
aggregating data from multiple data sources into a data platform, wherein first data from first data sources is aggregated directly into the data platform through an API and second data is aggregated through a pass-through tier;
transforming the first and the second data into structured data;
cataloging the structured data such that the structured data is stored as datasets; and
controlling access to the structured data and generating inferences for an entity and/or an owner of the structured data.

10. The non-transitory storage medium of claim 9, the operations further comprising receiving a service from the entity and running the service against the datasets to generate the inferences.

11. The non-transitory storage medium of claim 10, the operations further comprising restricting the service from copying the structured data to the entity.

12. The non-transitory storage medium of claim 9, the operations further comprising:
cataloging the structured data by content type; and
setting access levels for the entity.

13. The non-transitory storage medium of claim 9, entity is at least one of a service provider, a different end user, a retailer, or a consumer.

14. A non-transitory storage medium having stored therein instructions that are executable by one or more hardware processors to perform operations comprising:
receiving a request from an entity to obtain personal data;
providing the entity with an authorization;
sending the request and the authorization to a data platform of a user;
authenticating the authorization; and
sending the personal data to the entity from the data platform.

15. The non-transitory storage medium of claim 14, the operations further comprising receiving the request at a client device, wherein the client device is configured to provide the authorization.

16. The non-transitory storage medium of claim 15, wherein the authorization is one of a QR code, a number or alphanumerical sequence, or an EMB.

17. The non-transitory storage medium of claim 14, the operations further comprising sending the request and the authorization to a pass-through tier, wherein the data platform retrieves the request and the authorization from the pass-through tier.

18. The non-transitory storage medium of claim 15, the operations further comprising accessing the data based on permissions associated with the entity, wherein the entity is at least one of a service provider, a different end user, a retailer, or a consumer and wherein the client device is at least one of a mobile device or an IoT device and wherein the authorization is configured in advance or performed on a case-by-case basis.

19. The non-transitory storage medium of claim 18, the operations, further comprising sending the personal data through a client device to the service provider.

20. The non-transitory storage medium of claim 14, further comprising a user interface that allows a user to interact with the data platform, wherein the user interface is configured for setting permissions on the personal data, sharing the personal data, and/or viewing the personal data,
wherein the authorization, when received by the personal data platform, is authenticated and the personal data is retrieved in accordance with permissions associated with the entity and/or the authorization.
